(19) United States
(12) Patent Application Publication
(10) Pub. No.: US 2026/0097661 A1
(43) Pub. Date: Apr. 9, 2026

(54) ELECTRIC MOTOR CONTROL APPARATUS AND VEHICLE

(71) Applicant: SUBARU CORPORATION, Tokyo (JP)

(72) Inventor: Naoki HASHIMOTO, Tokyo (JP)

(21) Appl. No.: 19/339,481

(22) Filed: Sep. 25, 2025

(30) Foreign Application Priority Data
Oct. 8, 2024 (JP) 2024-176645

(51) Int. Cl. B60L 15/20; B60K 1/02; H02P 5/74; H02P 23/14

(52) U.S. Cl. CPC B60L 15/20; B60K 1/02; H02P 5/74; H02P 23/14; B60L 2240/421; B60L 2240/423; B60L 2240/429; B60L 2240/465

(57) ABSTRACT

An electric motor control apparatus includes a control circuit that generates a first torque command value and a second torque command value that fluctuate at a predetermined frequency, determines a torque of a first electric motor for a front wheel, based on the first torque command value and a third torque command value that corresponds to a driving operation performed by a driver, and determines a torque of a second electric motor for a rear wheel, based on the second torque command value and the third torque command value. The control circuit generates the first and second torque command values to make their phases opposite to each other when a vehicle is in a grip state, and generates the first and second torque command values to make their phases the same as each other when the vehicle is in a stick-slip state.

### CROSS-REFERENCE TO RELATED APPLICATIONS

The present application claims priority from Japanese Patent Application No. 2024-176645 filed on October 8, 2024, the entire contents of which are hereby incorporated by reference.

### BACKGROUND

The disclosure relates to an electric motor control apparatus that controls an operation of an electric motor and to a vehicle including the electric motor control apparatus.

A vehicle such as an automobile can slip depending on, for example, a road condition. For example, Japanese Unexamined Patent Application Publication No. 2020-025425 discloses a technique of monitoring a current that flows through an electric motor, and detecting a slip of a tire based on the current.

### SUMMARY

An aspect of the disclosure provides an electric motor control apparatus configured to be applied to a vehicle. The electric motor control apparatus includes a control circuit. The control circuit is configured to: generate a first torque command value and a second torque command value that fluctuate at a predetermined frequency; determine, based on the first torque command value and a third torque command value, a torque of a first electric motor configured to generate a driving force of a front wheel of the vehicle, the third torque command value corresponding to a driving operation performed by a driver who drives the vehicle; and determine, based on the second torque command value and the third torque command value, a torque of a second electric motor configured to generate a driving force of a rear wheel of the vehicle. The control circuit is configured to determine whether the vehicle is in a grip state or a stick-slip state, based on one or both of a first parameter corresponding to a rotational speed of the first electric motor and a second parameter corresponding to a rotational speed of the second electric motor. The control circuit is configured to, when the vehicle is in the grip state, generate the first torque command value and the second torque command value to make a phase of the first torque command value and a phase of the second torque command value opposite to each other. The control circuit is configured to, when the vehicle is in the stick-slip state, generate the first torque command value and the second torque command value to make the phase of the first torque command value and the phase of the second torque command value same as each other.

An aspect of the disclosure provides a vehicle including a first electric motor, a second electric motor, a sensor, and a control circuit. The first electric motor is configured to generate a driving force of a front wheel of the vehicle. The second electric motor is configured to generate a driving force of a rear wheel of the vehicle. The sensor is configured to perform a detection of one or both of a first parameter corresponding to a rotational speed of the first electric motor and a second parameter corresponding to a rotational speed of the second electric motor. The control circuit is configured to: generate a first torque command value and a second torque command value that fluctuate at a predetermined frequency; determine a torque of the first electric motor, based on the first torque command value and a third torque command value that corresponds to a driving operation performed by a driver who drives the vehicle; and determine a torque of the second electric motor, based on the second torque command value and the third torque command value. The control circuit is configured to determine whether the vehicle is in a grip state or a stick-slip state, based on a result of the detection performed by the sensor. The control circuit is configured to, when the vehicle is in the grip state, generate the first torque command value and the second torque command value to make a phase of the first torque command value and a phase of the second torque command value opposite to each other. The control circuit is configured to, when the vehicle is in the stick-slip state, generate the first torque command value and the second torque command value to make the phase of the first torque command value and the phase of the second torque command value same as each other.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the disclosure.

FIG. 1 is an explanatory diagram illustrating an example of a vehicle according to one example embodiment of the disclosure.

FIG. 2 is a flowchart illustrating an operation example of a control circuit illustrated in FIG. 1.

FIG. 3 is an explanatory diagram illustrating the operation example of the control circuit illustrated in FIG. 1.

FIG. 4 is another explanatory diagram illustrating the operation example of the control circuit illustrated in FIG. 1.

FIG. 5 is an explanatory diagram illustrating an example of a vehicle according to a modification example.

### DETAILED DESCRIPTION

What is desired for a vehicle is to allow a driver to intuitively grasp a behavior of the vehicle.

It is desirable to provide an electric motor control apparatus and a vehicle that each make it possible to allow a driver to intuitively grasp a behavior of the vehicle.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### Example Embodiment

### Configuration Example

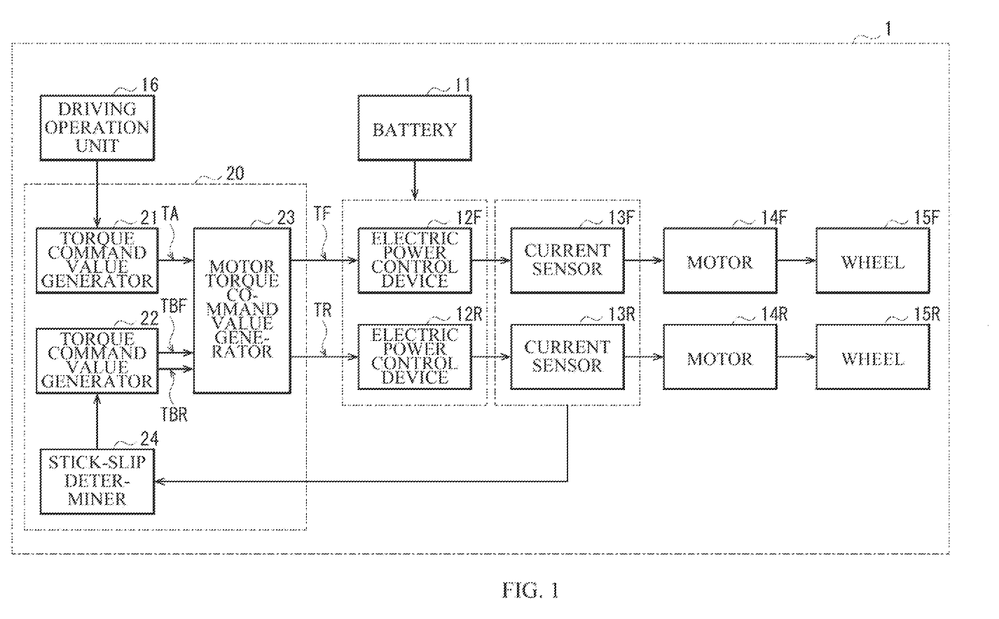

FIG. 1 illustrates a configuration example of a vehicle 1 including an electric motor control apparatus, e.g., a control circuit 20, according to an example embodiment. The vehicle 1 may be an electric vehicle. The vehicle 1 may include a battery 11, electric power control devices 12F and 12R, current sensors 13F and 13R, motors 14F and 14R, wheels 15F and 15R, a driving operation unit 16, and the control circuit 20. In the vehicle 1, the two motors 14F and 14R may thus be provided to drive the wheel 15F serving as a front wheel based on a driving force generated by the motor 14F, and to drive the wheel 15R serving as a rear wheel based on a driving force generated by the motor 14R.

The battery 11 may be configured to store electric power and supply direct-current electric power to the electric power control devices 12F and 12R. The battery 11 may be further configured to store electric power supplied from the electric power control devices 12F and 12R.

The electric power control device 12F may be configured to control electric power to be supplied to the motor 14F for the front wheel. The electric power control device 12F may include, for example, an inverter. The electric power control device 12F may convert the direct-current electric power supplied from the battery 11 into alternating-current electric power, based on a motor torque command value supplied from the control circuit 20, and supply the alternating-current electric power to the motor 14F via the current sensor 13F. The electric power control device 12F may be further configured to supply the electric power supplied from the motor 14F to the battery 11.

Similarly, the electric power control device 12R may be configured to control electric power to be supplied to the motor 14R for the rear wheel. The electric power control device 12R may include, for example, an inverter. The electric power control device 12R may convert the direct-current electric power supplied from the battery 11 into alternating-current electric power, based on a motor torque command value supplied from the control circuit 20, and supply the alternating-current electric power to the motor 14R via the current sensor 13R. The electric power control device 12R may be further configured to supply the electric power supplied from the motor 14R to the battery 11.

The current sensor 13F may be configured to detect a drive current of the motor 14F. Similarly, the current sensor 13R may be configured to detect a drive current of the motor 14R. The current sensors 13F and 13R may each provide a detection result to the control circuit 20.

The motor 14F may be configured to generate the driving force as mechanical energy based on the alternating-current electric power supplied from the electric power control device 12F. Further, the motor 14F may transmit the driving force to the wheel 15F via a drive mechanism. Non-limiting examples of the drive mechanism may include a differential gear and a drive shaft. The motor 14F may be configured to operate also as an electric power generator that generates electric power based on the mechanical energy supplied from the wheel 15F via the drive mechanism. The motor 14F may be configured to supply the generated alternating-current electric power to the electric power control device 12F.

Similarly, the motor 14R may be configured to generate the driving force as mechanical energy based on the alternating-current electric power supplied from the electric power control device 12R. Further, the motor 14R may transmit the driving force to the wheel 15R via a drive mechanism. Non-limiting examples of the drive mechanism may include a differential gear and a drive shaft. The motor 14R may be configured to operate also as an electric power generator that generates electric power based on the mechanical energy supplied from the wheel 15R via the drive mechanism. The motor 14R may be configured to supply the generated alternating-current electric power to the electric power control device 12R.

The wheel 15F may be a drive wheel serving as the front wheel of the vehicle 1. The wheel 15F may be configured to rotate about an axle based on the driving force supplied from the motor 14F via the drive mechanism, to thereby cause the vehicle 1 to travel on a road surface.

Similarly, the wheel 15R may be a drive wheel serving as the rear wheel of the vehicle 1. The wheel 15R may be configured to rotate about an axle based on the driving force supplied from the motor 14R via the drive mechanism, to thereby cause the vehicle 1 to travel on the road surface.

The driving operation unit 16 may include, for example, a steering wheel, an accelerator pedal, a brake pedal, and various levers to be operated by a driver when the driver drives the vehicle 1.

The control circuit 20 may be, for example, an electronic control unit (ECU). The control circuit 20 may include, for example, one or more processors and one or more memories. The control circuit 20 may operate as torque command value generators 21 and 22, a motor torque command value generator 23, and a stick-slip determiner 24 by executing software.

The torque command value generator 21 may be configured to generate a torque command value TA indicating a command value of torques of the motors 14F and 14R, based on an operation performed by the driver on the driving operation unit 16.

The torque command value generator 22 may be configured to generate a torque command value TBF indicating a command value of the torque of the motor 14F, and a torque command value TBR indicating a command value of the torque of the motor 14R, based on a determination result of the stick-slip determiner 24. The torque command value generator 22 may generate the torque command values TBF and TBR to make the torque command values TBF and TBR fluctuate at a predetermined frequency (e.g., about 10 Hz to about 30 Hz). Amplitudes of the torque command values TBF and TBR may change, for example, in accordance with the torque command value TA generated by the torque command value generator 21. In one example, the amplitudes of the torque command values TBF and TBR may be, for example, about 10% of the torque command value TA. The torque command value generator 22 may generate the torque command values TBF and TBR depending on whether the vehicle 1 is in a grip state or in a stick-slip state, based on the determination result of the stick-slip determiner 24. The grip state is a state in which the wheels 15F and 15R are not slipping on the road surface, i.e., a state in which the vehicle 1 is able to travel in accordance with the rotation of the wheels 15F and 15R. The stick-slip state is a state that can occur near a grip limit. In the stick-slip state, a slip state in which the wheels 15F and 15R slip on the road surface occurs intermittently. In one example, in the stick-slip state, the grip state and the slip state may occur alternately in a cycle of, for example, about 100 Hz. When the vehicle 1 is in the grip state, the torque command value generator 22 may generate the torque command values TBF and TBR to make a phase of the torque command value TBF and a phase of the torque command value TBR opposite to each other. When the vehicle 1 is in the stick-slip state, the torque command value generator 22 may generate the torque command values TBF and TBR to make the phase of the torque command value TBF and the phase of the torque command value TBR the same as each other.

The motor torque command value generator 23 may be configured to generate a motor torque command value TF indicating a command value of the torque of the motor 14F for the front wheel, and a motor torque command value TR indicating a command value of the torque of the motor 14R for the rear wheel, based on the torque command value TA generated by the torque command value generator 21 and the torque command values TBF and TBR generated by the torque command value generator 22. In one example, the motor torque command value generator 23 may generate the motor torque command value TF by adding the torque command value TA generated by the torque command value generator 21 and the torque command value TBF generated by the torque command value generator 22 together. Further, the motor torque command value generator 23 may generate the motor torque command value TR by adding the torque command value TA generated by the torque command value generator 21 and the torque command value TBR generated by the torque command value generator 22 together.

The stick-slip determiner 24 may be configured to determine whether the vehicle 1 is in the grip state or the stick-slip state based on the detection results of the current sensors 13F and 13R. When the vehicle 1 enters the stick-slip state, for example, a mechanical load from the viewpoint of the motor 14F may decrease, which may cause a rotational speed of the motor 14F to rapidly increase. Thus, a counter electromotive force may increase at the motor 14F, which may cause the drive current that drives the motor 14F to decrease. The same may apply to the motor 14R, and the drive current that drives the motor 14R may decrease when the vehicle 1 enters the stick-slip state. The stick-slip determiner 24 may determine whether the vehicle 1 is in the stick-slip state by detecting the reductions in the drive currents based on the detection results of the current sensors 13F and 13R.

In one embodiment, the control circuit 20 may serve as a "control circuit". In one embodiment, the motor 14F may serve as a "first electric motor". In one embodiment, the motor 14R may serve as a "second electric motor". In one embodiment, the wheel 15F may serve as a "front wheel". In one embodiment, the wheel 15R may serve as a "rear wheel". In one embodiment, the current sensors 13F and 13R may each serve as a "sensor". In one embodiment, the torque command value TBF may serve as a "first torque command value". In one embodiment, the torque command value TBR may serve as a "second torque command value". In one embodiment, the torque command value TA may serve as a "third torque command value". In one embodiment, the drive current of the motor 14F may serve as a "first parameter". In one embodiment, the drive current of the motor 14R may serve as a "second parameter".

### Operation and Workings

Next, an operation and workings of the vehicle 1 according to the example embodiment will be described.

### Overview of Overall Operation

First, the operation of the vehicle 1 will be described with reference to FIG. 1. The battery 11 may store the electric power and supply the direct-current electric power to the electric power control devices 12F and 12R. The electric power control device 12F may control the electric power to be supplied to the motor 14F for the front wheel. The electric power control device 12R may control the electric power to be supplied to the motor 14R for the rear wheel. The current sensor 13F may detect the drive current of the motor 14F. The current sensor 13R may detect the drive current of the motor 14R. The motor 14F may generate the driving force as mechanical energy based on the alternating-current electric power supplied from the electric power control device 12F. The motor 14F may operate also as an electric power generator that generates electric power based on the mechanical energy supplied from the wheel 15F via the drive mechanism. The motor 14F may supply the generated alternating-current electric power to the electric power control device 12F. The wheel 15F may rotate about the axle based on the driving force supplied from the motor 14F via the drive mechanism, to thereby cause the vehicle 1 to travel on the road surface. The motor 14R may generate the driving force as mechanical energy based on the alternating-current electric power supplied from the electric power control device 12R. The motor 14R may operate also as an electric power generator that generates electric power based on the mechanical energy supplied from the wheel 15R via the drive mechanism. The motor 14R may supply the generated alternating-current electric power to the electric power control device 12R. The wheel 15R may rotate about the axle based on the driving force supplied from the motor 14R via the drive mechanism, to thereby cause the vehicle 1 to travel on the road surface.

The torque command value generator 21 of the control circuit 20 may generate the torque command value TA indicating the command value of the torques of the motors 14F and 14R, based on the operation performed by the driver on the driving operation unit 16. The torque command value generator 22 may generate the torque command value TBF indicating the command value of the torque of the motor 14F, and the torque command value TBR indicating the command value of the torque of the motor 14R, based on the determination result of the stick-slip determiner 24. The motor torque command value generator 23 may generate the motor torque command value TF indicating the command value of the torque of the motor 14F for the front wheel, and the motor torque command value TR indicating the command value of the torque of the motor 14R for the rear wheel, based on the torque command value TA generated by the torque command value generator 21 and the torque command values TBF and TBR generated by the torque command value generator 22. The stick-slip determiner 24 may determine whether the vehicle 1 is in the grip state or the stick-slip state based on the detection results of the current sensors 13F and 13R.

### Detailed Operation

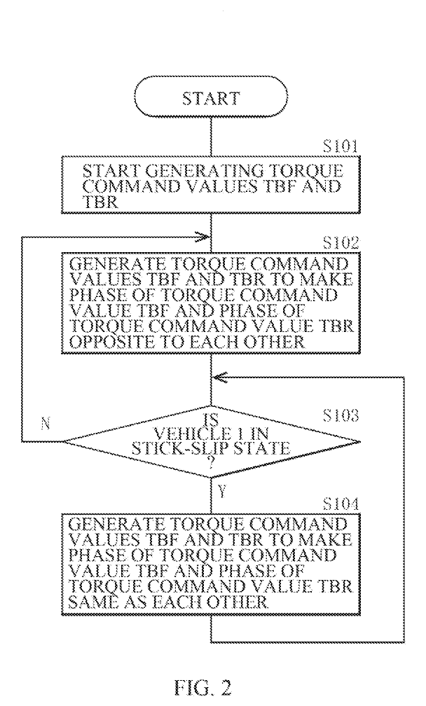

FIG. 2 illustrates an operation example of the torque command value generator 22.

Upon a start-up of a system of the vehicle 1, the torque command value generator 22 may start generating the torque command values TBF and TBR (step S101). The vehicle 1 may be in the grip state immediately after the vehicle 1 starts traveling.

The torque command value generator 22 may generate the torque command values TBF and TBR to make the phase of the torque command value TBF and the phase of the torque command value TBR opposite to each other (step S102).

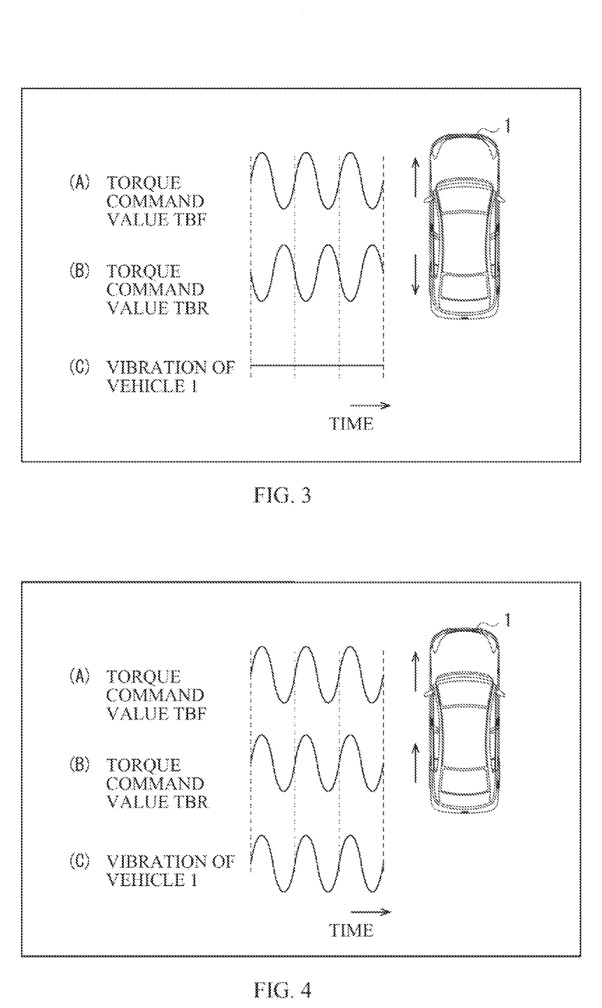

FIG. 3 illustrates a state of the vehicle 1 in step S102, where (A) illustrates a waveform of the torque command value TBF, (B) illustrates a waveform of the torque command value TBR, and (C) illustrates vibration of the vehicle 1. The torque command value generator 22 may generate the torque command values TBF and TBR to make the phase of the torque command value TBF and the phase of the torque command value TBR opposite to each other.

For example, when the torque command value TBF is a large value, the torque command value TBR is a small value ((A) and (B) of FIG. 3). However, the rotational speed of the motor 14F for the front wheel of the vehicle 1 and a rotational speed of the motor 14R for the rear wheel of the vehicle 1 match each other unless a slip occurs between the wheels and a common road surface. In other words, as indicated by arrows in FIG. 3, the wheel 15F serving as the front wheel of the vehicle 1 attempts to accelerate the vehicle 1, and the wheel 15R serving as the rear wheel of the vehicle 1 attempts to decelerate the vehicle 1. As a result, these two forces cancel each other out ((C) of FIG. 3).

Similarly, when the torque command value TBF is a small value, the torque command value TBR is a large value ((A) and (B) of FIG. 3). Thus, the wheel 15F serving as the front wheel of the vehicle 1 attempts to decelerate the vehicle 1, and the wheel 15R serving as the rear wheel of the vehicle 1 attempts to accelerate the vehicle 1. As a result, these two forces cancel each other out ((C) of FIG. 3).

Because the phase of the torque command value TBF and the phase of the torque command value TBR are thus opposite to each other in the vehicle 1, the force by which the wheel 15F serving as the front wheel attempts to move the vehicle 1 and the force by which the wheel 15R serving as the rear wheel attempts to move the vehicle 1 cancel each other out. This makes it possible to suppress the vibration of the vehicle 1.

Thereafter, the torque command value generator 22 may check whether the vehicle 1 is in the stick-slip state (step S103). In one example, the stick-slip determiner 24 may determine whether the vehicle 1 is in the grip state or the stick-slip state based on the detection results of the current sensors 13F and 13R. The torque command value generator 22 may check whether the vehicle 1 is in the stick-slip state based on the determination result of the stick-slip determiner 24.

If the vehicle 1 is in the grip state ("N" in step S103), the process may return to step S102. In this manner, the process of step S102 may be continued until the vehicle 1 enters the stick-slip state.

If the vehicle 1 is in the stick-slip state ("Y" in step S103), the torque command value generator 22 may generate the torque command values TBF and TBR to make the phase of the torque command value TBF and the phase of the torque command value TBR the same as each other (step S104).

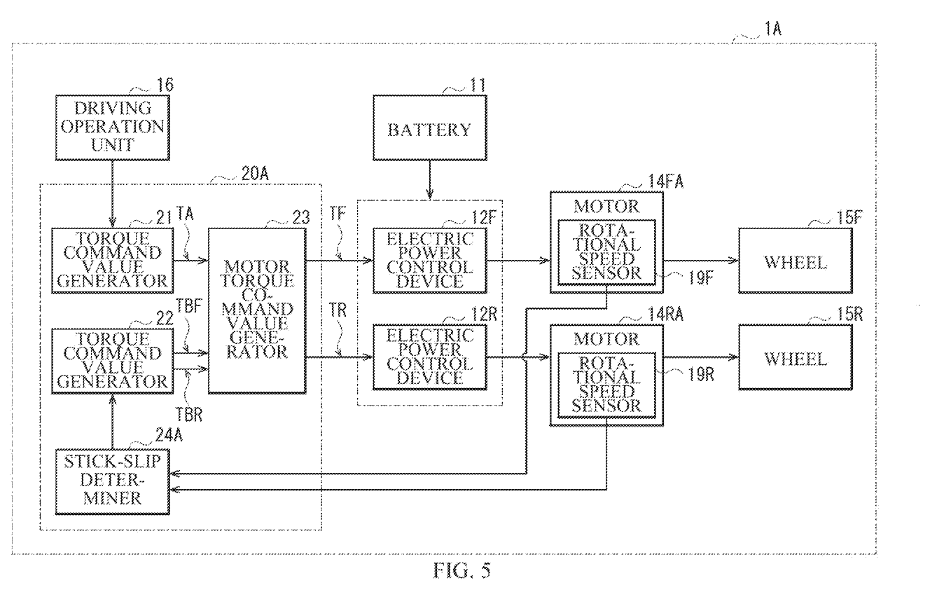

FIG. 4 illustrates a state of the vehicle 1 in step S104. The torque command value generator 22 may generate the torque command values TBF and TBR to make the phase of the torque command value TBF and the phase of the torque command value TBR the same as each other.

For example, when the torque command value TBF is a large value, the torque command value TBR is also a large value ((A) and (B) of FIG. 4). Accordingly, the rotational speed of the motor 14F for the front wheel of the vehicle 1 and the rotational speed of the motor 14R for the rear wheel of the vehicle 1 both become high. Thus, as indicated by arrows in FIG. 4, the wheel 15F serving as the front wheel of the vehicle 1 and the wheel 15R serving as the rear wheel of the vehicle 1 both attempt to accelerate the vehicle 1. As a result, the vehicle 1 accelerates ((C) of FIG. 4).

Similarly, for example, when the torque command value TBF is a small value, the torque command value TBR is also a small value ((A) and (B) of FIG. 4). Thus, the wheel 15F serving as the front wheel of the vehicle 1 and the wheel 15R serving as the rear wheel of the vehicle 1 both attempt to decelerate the vehicle 1. As a result, the vehicle 1 decelerates ((C) of FIG. 4).

Because the phase of the torque command value TBF and the phase of the torque command value TBR are thus the same as each other in the vehicle 1, the vehicle 1 vibrates by repeating the acceleration and the deceleration. It is possible for the driver to intuitively grasp that the vehicle 1 is in the stick-slip state based on the vibration.

Thereafter, the process may return to step S103. In this manner, the process of step S104 may be continued until the vehicle 1 enters the grip state.

As described above, the vehicle 1 includes the control circuit 20 configured to: generate the first torque command value (the torque command value TBF) and the second torque command value (the torque command value TBR) that fluctuate at the predetermined frequency; determine, based on the first torque command value (the torque command value TBF) and the third torque command value (the torque command value TA), the torque of the first electric motor (the motor 14F) configured to generate the driving force of the front wheel (the wheel 15F) of the vehicle 1, the third torque command value (the torque command value TA) corresponding to the driving operation performed by the driver who drives the vehicle 1; and determine, based on the second torque command value (the torque command value TBR) and the third torque command value (the torque command value TA), the torque of the second electric motor (the motor 14R) configured to generate the driving force of the rear wheel (the wheel 15R) of the vehicle 1. The control circuit 20 is configured to determine whether the vehicle 1 is in the grip state or the stick-slip state, based on one or both of the first parameter (the drive current of the motor 14F) corresponding to the rotational speed of the first electric motor (the motor 14F) and the second parameter (the drive current of the motor 14R) corresponding to the rotational speed of the second electric motor (the motor 14R). The control circuit 20 is configured to, when the vehicle 1 is in the grip state, generate the first torque command value (the torque command value TBF) and the second torque command value (the torque command value TBR) to make the phase of the first torque command value (the torque command value TBF) and the phase of the second torque command value (the torque command value TBR) opposite to each other. The control circuit 20 is configured to, when the vehicle 1 is in the stick-slip state, generate the first torque command value (the torque command value TBF) and the second torque command value (the torque command value TBR) to make the phase of the first torque command value (the torque command value TBF) and the phase of the second torque command value (the torque command value TBR) the same as each other. This helps the vehicle 1 to allow the driver to intuitively grasp a behavior of the vehicle 1.

In other words, when the vehicle 1 is in the grip state, the phase of the torque command value TBF and the phase of the torque command value TBR are opposite to each other. Thus, the force by which the wheel 15F serving as the front wheel attempts to move the vehicle 1 and the force by which the wheel 15R serving as the rear wheel attempts to move the vehicle 1 cancel each other out, which makes it possible to suppress the vibration of the vehicle 1. Further, when the vehicle 1 is in the stick-slip state, the phase of the torque command value TBF and the phase of the torque command value TBR are the same as each other. Thus, the vehicle 1 vibrates by repeating the acceleration and the deceleration. This helps the driver to intuitively grasp that the vehicle 1 is in the stick-slip state based on the vibration.

Further, the control circuit 20 generates the torque command values TBF and TBR that fluctuate at the predetermined frequency in the grip state as well, which makes it easier to induce the stick-slip state near the grip limit. In other words, the stick-slip state can occur in a narrow range near the grip limit. Because the torque command values TBF and TBR fluctuate at the predetermined frequency in the vehicle 1, the state of the vehicle 1 shifts back and forth across the range near the grip limit. This makes it easier for the vehicle 1 to induce the stick-slip state near the grip limit, which allows the vehicle 1 to be in the stick-slip state for a longer period. As a result, it is possible to extend a period in which the vehicle 1 vibrates, which helps the driver to intuitively grasp that the vehicle 1 is in the stick-slip state based on the vibration.

In some embodiments, the rotational speed of the first electric motor (the motor 14F) when the vehicle 1 is in the stick-slip state may be faster than the rotational speed of the first electric motor (the motor 14F) when the vehicle 1 is in the grip state, and the rotational speed of the second electric motor (the motor 14R) when the vehicle 1 is in the stick-slip state may be faster than the rotational speed of the second electric motor (the motor 14R) when the vehicle 1 is in the grip state. Accordingly, when the vehicle 1 is in the stick-slip state, the counter electromotive forces may increase at the motors 14F and 14R, which may cause the drive currents of the motors 14F and 14R to decrease. This helps the stick-slip determiner 24 of the control circuit 20 to determine whether the vehicle 1 is in the stick-slip state by detecting the reductions in the drive currents based on the detection results of the current sensors 13F and 13R.

### Example Effects

As described above, in the example embodiment, the control circuit is configured to: generate the first torque command value and the second torque command value that fluctuate at the predetermined frequency; determine, based on the first torque command value and the third torque command value, the torque of the first electric motor configured to generate the driving force of the front wheel of the vehicle, the third torque command value corresponding to the driving operation performed by the driver who drives the vehicle; and determine, based on the second torque command value and the third torque command value, the torque of the second electric motor configured to generate the driving force of the rear wheel of the vehicle. The control circuit is configured to determine whether the vehicle is in the grip state or the stick-slip state, based on one or both of the first parameter corresponding to the rotational speed of the first electric motor and the second parameter corresponding to the rotational speed of the second electric motor. The control circuit is configured to, when the vehicle is in the grip state, generate the first torque command value and the second torque command value to make the phase of the first torque command value and the phase of the second torque command value opposite to each other. The control circuit is configured to, when the vehicle is in the stick-slip state, generate the first torque command value and the second torque command value to make the phase of the first torque command value and the phase of the second torque command value the same as each other. This helps the vehicle to allow the driver to intuitively grasp the behavior of the vehicle.

In some embodiments, the rotational speed of the first electric motor when the vehicle is in the stick-slip state may be faster than the rotational speed of the first electric motor when the vehicle is in the grip state, and the rotational speed of the second electric motor when the vehicle is in the stick-slip state may be faster than the rotational speed of the second electric motor when the vehicle is in the grip state. This helps the vehicle to determine whether the vehicle is in the stick-slip state.

### Modification Example

In the example embodiment described above, the stick-slip determiner 24 may determine whether the vehicle 1 is in the grip state or the stick-slip state, based on the drive currents of the motors 14F and 14R, but the disclosure is not limited thereto. In some embodiments, for example, it may be determined whether the vehicle 1 is in the grip state or the stick-slip state, based on the rotational speeds of the motors 14F and 14R. The following describes a vehicle 1A according to the modification example in detail.

FIG. 5 illustrates a configuration example of the vehicle 1A. The vehicle 1A may include the battery 11, the electric power control devices 12F and 12R, motors 14FA and 14RA, the wheels 15F and 15R, the driving operation unit 16, and a control circuit 20A.

The motor 14FA may include a rotational speed sensor 19F. The rotational speed sensor 19F may be configured to detect the rotational speed of the motor 14FA. The motor 14RA may include a rotational speed sensor 19R. The rotational speed sensor 19R may be configured to detect the rotational speed of the motor 14RA. The rotational speed sensors 19F and 19R may each provide a detection result to the control circuit 20A.

The control circuit 20A may operate as the torque command value generators 21 and 22, the motor torque command value generator 23, and a stick-slip determiner 24A by executing software.

The stick-slip determiner 24A may be configured to determine whether the vehicle 1 is in the grip state or the stick-slip state based on the detection results of the rotational speed sensors 19F and 19R. When the vehicle 1 enters the stick-slip state, for example, the mechanical load from the viewpoint of the motor 14F may decrease, which may cause the rotational speed of the motor 14F to rapidly increase. The same may apply to the motor 14R, and the rotational speed of the motor 14R may rapidly increase when the vehicle 1 enters the stick-slip state. The stick-slip determiner 24A may determine whether the vehicle 1 is in the stick-slip state by detecting the increases in the rotational speeds based on the detection results of the rotational speed sensors 19F and 19R.

In one embodiment, the rotational speed sensors 19F and 19R may each serve as the "sensor". In one embodiment, the rotational speed of the motor 14F may serve as the "first parameter". In one embodiment, the rotational speed of the motor 14R may serve as the "second parameter".

Although some embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

For example, in the example embodiment described above, the stick-slip determiner 24 may determine whether the vehicle 1 is in the grip state or the stick-slip state based on the detection results of the current sensors 13F and 13R, but the disclosure is not limited thereto. In some embodiments, the stick-slip determiner 24 may determine whether the vehicle 1 is in the grip state or the stick-slip state based on the detection result of the current sensor 13F, or may determine whether the vehicle 1 is in the grip state or the stick-slip state based on the detection result of the current sensor 13R.

The effects described herein are merely exemplary, and effects of the disclosure are not limited to the effects described herein. Accordingly, any other effects may be achieved by any embodiment of the disclosure.

Furthermore, the disclosure may encompass at least the following embodiments.

(1) An electric motor control apparatus to be applied to a vehicle, the electric motor control apparatus including

a control circuit configured to

generate a first torque command value and a second torque command value that fluctuate at a predetermined frequency,

determine, based on the first torque command value and a third torque command value, a torque of a first electric motor configured to generate a driving force of a front wheel of the vehicle, the third torque command value corresponding to a driving operation performed by a driver who drives the vehicle, and

determine, based on the second torque command value and the third torque command value, a torque of a second electric motor configured to generate a driving force of a rear wheel of the vehicle, in which

the control circuit is configured to

determine whether the vehicle is in a grip state or a stick-slip state, based on one or both of a first parameter corresponding to a rotational speed of the first electric motor and a second parameter corresponding to a rotational speed of the second electric motor,

when the vehicle is in the grip state, generate the first torque command value and the second torque command value to make a phase of the first torque command value and a phase of the second torque command value opposite to each other, and

when the vehicle is in the stick-slip state, generate the first torque command value and the second torque command value to make the phase of the first torque command value and the phase of the second torque command value same as each other.

(2) The electric motor control apparatus according to (1), in which

the rotational speed of the first electric motor when the vehicle is in the stick-slip state is faster than the rotational speed of the first electric motor when the vehicle is in the grip state, and

the rotational speed of the second electric motor when the vehicle is in the stick-slip state is faster than the rotational speed of the second electric motor when the vehicle is in the grip state.

(3) The electric motor control apparatus according to (1) or (2), in which

the first parameter includes a drive current of the first electric motor, and

the second parameter includes a drive current of the second electric motor.

(4) The electric motor control apparatus according to (1) or (2), in which

the first parameter includes the rotational speed of the first electric motor, and

the second parameter includes the rotational speed of the second electric motor.

A vehicle including:

a first electric motor configured to generate a driving force of a front wheel of the vehicle;

a second electric motor configured to generate a driving force of a rear wheel of the vehicle;

a sensor configured to perform a detection of one or both of a first parameter corresponding to a rotational speed of the first electric motor and a second parameter corresponding to a rotational speed of the second electric motor; and

a control circuit configured to

generate a first torque command value and a second torque command value that fluctuate at a predetermined frequency,

determine a torque of the first electric motor, based on the first torque command value and a third torque command value that corresponds to a driving operation performed by a driver who drives the vehicle, and

determine a torque of the second electric motor, based on the second torque command value and the third torque command value, in which

the control circuit is configured to

determine whether the vehicle is in a grip state or a stick-slip state, based on a result of the detection performed by the sensor,

when the vehicle is in the grip state, generate the first torque command value and the second torque command value to make a phase of the first torque command value and a phase of the second torque command value opposite to each other, and

when the vehicle is in the stick-slip state, generate the first torque command value and the second torque command value to make the phase of the first torque command value and the phase of the second torque command value same as each other.

The limitations in the claims are to be interpreted broadly based on the language employed in the claims and not limited to examples described in this specification or during the prosecution of the application, and the examples are to be construed as non-exclusive.

As used in this specification and the appended claims, the singular forms "a", "an", and "the" include, especially in the context of the claims, are to be construed to cover both the singular and the plural, unless otherwise indicated herein or clearly contradicted by context.

Throughout this specification and the appended claims, unless the context requires otherwise, the terms "comprise", "include", "have", and their variations are to be construed to cover the inclusion of a stated element, integer, or step but not the exclusion of any other non-stated element, integer, or step.

The use of the terms first, second, etc. does not denote any order or importance, but rather the terms first, second, etc. are used to distinguish one element from another.

The terms "substantially" "about", and their variants having similar meanings thereto are defined as being largely but not necessarily wholly what is specified as understood by one of ordinary skill in the art.

The terms "disposed on", "provided on", and its variants having similar meanings thereto as used herein refer to elements disposed directly in contact with each other or indirectly by having intervening structures therebetween.

Each of the control circuit 20 illustrated in FIG. 1 and the control circuit 20A illustrated in FIG. 5 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of each of the control circuit 20 illustrated in FIG. 1 and the control circuit 20A illustrated in FIG. 5. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of each of the control circuit 20 illustrated in FIG. 1 and the control circuit 20A illustrated in FIG. 5.

1. An electric motor control apparatus configured to be applied to a vehicle, the electric motor control apparatus comprising
a control circuit configured to
generate a first torque command value and a second torque command value that fluctuate at a predetermined frequency,
determine, based on the first torque command value and a third torque command value, a torque of a first electric motor configured to generate a driving force of a front wheel of the vehicle, the third torque command value corresponding to a driving operation performed by a driver who drives the vehicle, and
determine, based on the second torque command value and the third torque command value, a torque of a second electric motor configured to generate a driving force of a rear wheel of the vehicle, wherein
the control circuit is configured to
determine whether the vehicle is in a grip state or a stick-slip state, based on one or both of a first parameter corresponding to a rotational speed of the first electric motor and a second parameter corresponding to a rotational speed of the second electric motor,
when the vehicle is in the grip state, generate the first torque command value and the second torque command value to make a phase of the first torque command value and a phase of the second torque command value opposite to each other, and
when the vehicle is in the stick-slip state, generate the first torque command value and the second torque command value to make the phase of the first torque command value and the phase of the second torque command value same as each other.

2. The electric motor control apparatus according to claim 1, wherein
the rotational speed of the first electric motor when the vehicle is in the stick-slip state is faster than the rotational speed of the first electric motor when the vehicle is in the grip state, and
the rotational speed of the second electric motor when the vehicle is in the stick-slip state is faster than the rotational speed of the second electric motor when the vehicle is in the grip state.

3. The electric motor control apparatus according to claim 1, wherein
the first parameter comprises a drive current of the first electric motor, and
the second parameter comprises a drive current of the second electric motor.

4. The electric motor control apparatus according to claim 1, wherein
the first parameter comprises the rotational speed of the first electric motor, and
the second parameter comprises the rotational speed of the second electric motor.

5. A vehicle comprising:
a first electric motor configured to generate a driving force of a front wheel of the vehicle;
a second electric motor configured to generate a driving force of a rear wheel of the vehicle;
a sensor configured to perform a detection of one or both of a first parameter corresponding to a rotational speed of the first electric motor and a second parameter corresponding to a rotational speed of the second electric motor; and
a control circuit configured to
generate a first torque command value and a second torque command value that fluctuate at a predetermined frequency,
determine a torque of the first electric motor, based on the first torque command value and a third torque command value that corresponds to a driving operation performed by a driver who drives the vehicle, and
determine a torque of the second electric motor, based on the second torque command value and the third torque command value, wherein
the control circuit is configured to
determine whether the vehicle is in a grip state or a stick-slip state, based on a result of the detection performed by the sensor,
when the vehicle is in the grip state, generate the first torque command value and the second torque command value to make a phase of the first torque command value and a phase of the second torque command value opposite to each other, and
when the vehicle is in the stick-slip state, generate the first torque command value and the second torque command value to make the phase of the first torque command value and the phase of the second torque command value same as each other.
